(19) United States
(12) Patent Application Publication
(10) Pub. No.: US 2005/0112357 A1
(43) Pub. Date: May 26, 2005

(54) Foam substrate on polymeric film and method of manufacture

(76) Inventors: Michael P. Williams II, Bloomfield Hills, MI (US); Richard Kucejko, Troy, MI (US); Robert J. Zander, Troy, MI (US); Michael C. Restaino, Birmingham, MI (US)

Correspondence Address: HARNESS, DICKEY & PIERCE, P.L.C., P.O. BOX 828, BLOOMFIELD HILLS, MI, 48303, US

(21) Appl. No.: 10/718,347

(22) Filed: Nov. 20, 2003

(51) Int. Cl. B32B 3/26

(52) U.S. Cl. 428/319.3; 428/319.7; 428/319.9

(57) ABSTRACT

A polymeric molded device having an exemplary use as a structural or reinforcing member for a vehicle includes a co-extruded multilayer film. The multilayer film includes at least a clear layer, a color layer joined to the clear layer, and a bulk layer joined to the color layer. The multilayer film is thermoformed into a structural shape. A foam layer is bonded to the bulk layer by injection or extrusion molding. The film and the foam layer, when bonded, form the structural member. The co-extruded multilayer film can also include the foam layer before thermoforming.

### FIELD OF THE INVENTION

The present invention relates in general to polymeric moldings and more specifically to a polymeric film and foam device and method of manufacture.

### BACKGROUND OF THE INVENTION

Component parts for vehicles, including vehicle bumpers, outer trim members, interior trim members and reinforcing members commonly use a polymeric foam within one or more cavities of the parts to increase part stiffness and reduce part weight. Because foam material typically does not meet surface finish requirements for finish appearance or for painting, a fascia, usually formed from a metal or a molded polymeric layer, forms the part's outer cover. The fascia is either coated or painted, or includes the desired color in the polymeric material. The foam is commonly preformed or cut to fit the outer cover and placed within a cavity of the outer cover. This process requires separate steps to form the fascia and foam, and at least an additional step to insert the foam, and trim the foam if required. Part cost increases with each manufacturing step.

A process is also known wherein liquid polymer is poured into a mold, shaped to closely match the outer cover, to form the foam material. This process involves mixing two liquefied component parts, typically a base polymer and a catalyst. The liquid foam mixture is poured into a mold and the part is allowed to solidify before removal from the mold. A chemical reaction occurs when the two component parts are mixed, resulting in expansion and hardening of the foam. This process is suitable for use in open, simple part molds, but may not be suitable to form complex geometric part shapes because the expanding foam may not enter or fill all cavities of the mold. There are also limitations in the foams made in this manner due to inherent material and process limitations.

### SUMMARY OF THE INVENTION

A molded device includes a co-extruded multilayer film. The multilayer film includes at least a color layer and a bulk layer joined to the color layer. A foam layer is bonded to the bulk layer. The film and the foam layer together operably form a structural unit.

In another embodiment of the present invention, a method for forming a multilayered polymeric component includes coextruding a film layer using the steps of forming a color layer, and binding the color layer to a bulk layer. The film layer is then thermoformed. The thermoformed film layer is positioned in a mold of a molding machine. A foam layer is bonded in the mold to the thermoformed film layer.

In still another preferred embodiment of the present invention, a process is provided for molding a vehicle component part. The process includes: extruding a polymeric film having at least one layer; thermoforming the polymeric film into a predetermined shape; positioning the predetermined shape in an injection mold; and pressure injecting a preheated foam mixture into the mold to operably bond the foam mixture to the polymeric film.

In yet another preferred embodiment of the present invention, a process for molding a vehicle component part comprises: creating a polymeric film; thermoforming the polymeric film into a predetermined shape; positioning the predetermined shape in an injection mold; and injecting a preheated foam mixture into the mold to operably bond the foam mixture to the polymeric film.

In still yet another preferred embodiment of the present invention, a method for forming a multilayered polymeric component includes simultaneously coextruding a multiple element layer having at least a color layer, a bulk layer and a foam layer. The co-extrusion includes the steps of: binding the color layer to the bulk layer; and bonding a foam layer to the bulk layer opposite to the color layer. The multiple element layer is sequentially transferred to a thermoforming device. The multiple element layer is thermoformed to operably form a completed part.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side elevational view of an automobile vehicle having multiple applications identified for a foam substrate on polymeric film component part of the present invention;

FIG. 2 is a perspective assembly view of an exemplary vehicle front bumper formed by the method of the present invention;

FIG. 3 is a cross-sectional view taken at section 3-3 of FIG. 2;

FIG. 4 is a cross-sectional view taken at section 4-4 of FIG. 3;

FIG. 5 is a cross-sectional view of a film of the present invention following a thermal forming step;

FIG. 6 is a cross-sectional elevational view of a two-part mold having a multilayered film of the present invention, prior to a foam injection step;

FIG. 7 is a cross-sectional view similar to FIG. 6 following an injection of foam into the mold of FIG. 6;

FIG. 8 is a cross-sectional view similar to FIG. 4, showing another preferred embodiment for a co-extruded film of the present invention;

FIG. 9 is a cross-sectional view of the co-extruded film of FIG. 8, following a thermal forming step;

FIG. 10 is a cross-sectional view similar to FIG. 8, showing a co-extruded film prior to bonding to a separately formed foam layer;

FIG. 11 is a cross-sectional view of the co-extruded film and separate foam layer of FIG. 10, following bonding of the film and foam layers and thermal forming of the resultant component; and

FIG. 12 is a diagram of the steps for forming a foam substrate and polymeric film part of the present invention.

### DETAILED DESCRIPTION OF THE PREFERRED EMBODIMENTS

The following description of the preferred embodiments is merely exemplary in nature and is in no way intended to limit the invention, its application, or uses.

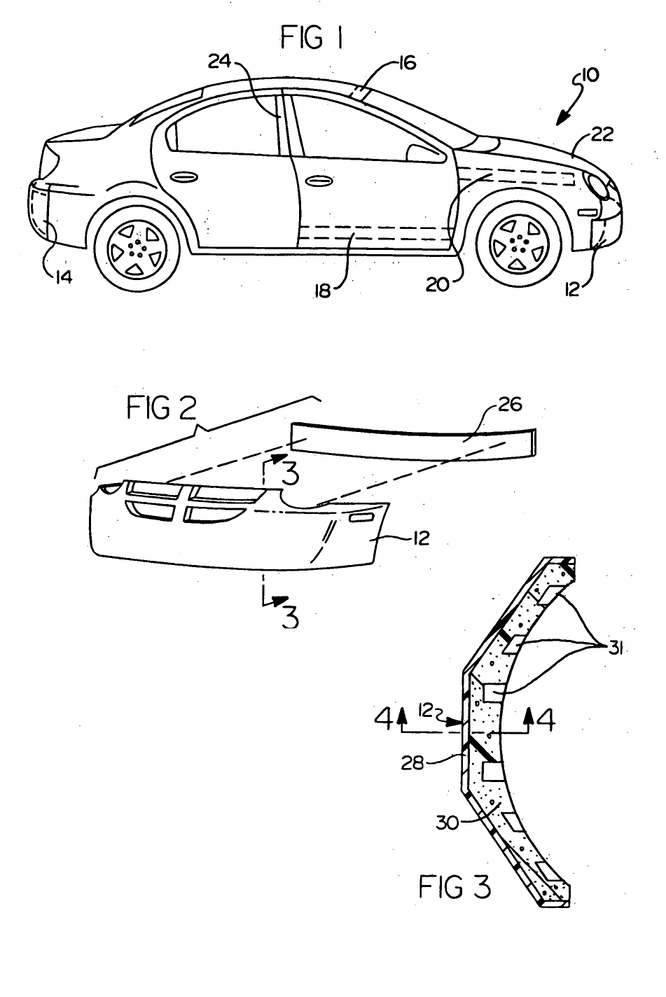

According to a preferred embodiment of the present invention, and as shown in FIG. 1, a vehicle 10 includes a plurality of component parts formed by the process of the present invention. Vehicle 10 is shown having a front bumper unit 12, a rear bumper 14, a roof trim member 16, a door trim member 18, a body panel member 20, a hood member 22 and at least one post member 24. Front bumper unit 12, rear bumper 14, roof trim member 16, door trim member 18, body panel member 20, hood member 22 and post member 24 are formed parts having a plurality of layers which will be better described in reference to FIGS. 3-7. It is noted that roof trim member 16, door trim member 18, body panel member 20, hood member 22 and post member 24 can be either internal or external component parts mounted to vehicle 10.

As best seen in FIG. 2, a completed front bumper unit 12 is mechanically joined to a bumper beam 26 which in turn is mechanically joined to vehicle 10 (shown in FIG. 1). Front bumper unit 12 is shown having a fascia for a bumper assembly commonly known in the automotive industry.

As shown in FIG. 3, front bumper unit 12 in an exemplary embodiment includes a film 28 bonded to a foam 30. A plurality of cavities 31 are also shown within foam 30. Cavities 31 are preferably used where a further weight reduction or a less stiff part is desirable for front bumper unit 12 or similar exemplary parts. The geometry shown for front bumper unit 12 is not intended to be limiting for the invention. A plurality of geometries can be used for a component formed by the process of the present invention.

Foam 30 is formed from a polymeric material combined with a blowing agent which together are heated to the melting temperature of the materials. A process for forming foam 30 and the materials used for forming foam 30 are described in U.S. patent application, entitled “Molded Foam Vehicle Energy Absorbing Device and Method of Manufacture”, filed Oct. 22, 2003, which is commonly assigned to the assignee of the present invention. The enclosure of the above-identified application is incorporated herein by reference.

As noted in the above application, base polymeric materials for foam 30 include at least one of polyurethane, polyethylene, polypropylene, polyester, polycarbonate/polyester alloy, ethylene vinyl acetate copolymer, amide, ionomer, polycarbonate, acrylonitrile butadiene styrene, polybutylene therephthalate, thermoplastic olefin, thermoplastic elastomer, polyethylene terephtalate, polyethylene terephtalate copolymer with glycol, acetyl, and/or polyphenyline oxide. Materials for the blowing agent include Hydrocerol® 1700, which is available from Clariant Corporation, Polybatch® XU-1515, which is available from A. Schulman Inc., azodicarbonamides, phenyltetrazoles or bicarbonates/acids known in the art.

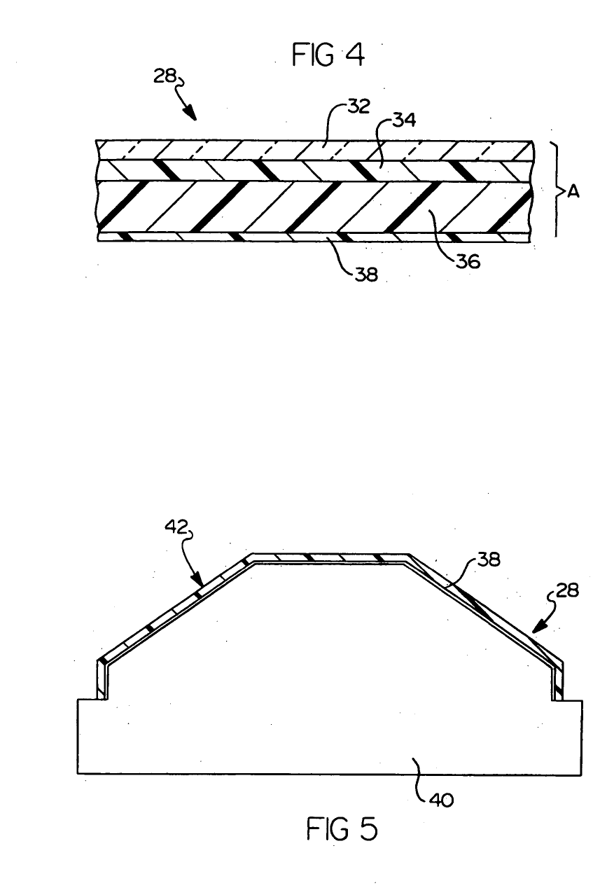

As shown in FIG. 4, film 28 commonly includes a plurality of layers of polymeric material. In a preferred embodiment, film 28 includes a clear layer 32, a color layer 34, and a bulk layer 36. Optionally, a back layer 38 is also used adjacent to bulk layer 36 opposite to color layer 34. Back layer 38 is a polymeric layer with suitable bonding attributes or is an adhesive, either of which is compatible with bulk layer 36, and is used when necessary to enhance the bond between film 28 and foam 30 (shown in FIG. 3). Clear layer 32 provides both color enhancement as well as a protective covering for color layer 34. Color layer 34 includes a polymeric material having a natural material color or having color pigment added to produce a desired color. When completed, film 28 includes a film thickness “A”, which preferably ranges between approximately 0.30 mm to approximately 1.25 mm thick. In a preferred embodiment, film thickness “A” is approximately 0.76 mm. Film thickness “A” can vary from the values given to modify part stiffness, to enhance the part color, to modify a foam energy absorption capability, etc.

Film 28 is preferably prepared in sheet form having perimeter dimensions suitable for encompassing the perimeter of a finished component part. Film 28 is manufactured according to processes known in the art including co-extrusion processes.

As best seen in FIG. 5, film 28 is preformed into a desirable shape using a thermoforming process. Film 28 is first heated, either in an oven or by local heating elements to a temperature suitable to make film 28 pliable. Back layer 38 of heated film 28 is positioned over a pre-cooled mold 40. Mold 40 is preformed into a desired finished component part shape. During “pre-cooling” mold 40 is brought to an ambient or lower than ambient temperature. An ambient temperature for purposes of this process is considered to be approximately 100° F. or lower. Mold 40 can be pre-cooled using any process known in the art, including cooled air, chilled water, or similar refrigeration processes. When heated film 28 contacts pre-cooled mold 40, a shaped film member 42 is formed having the approximate shape of mold 40.

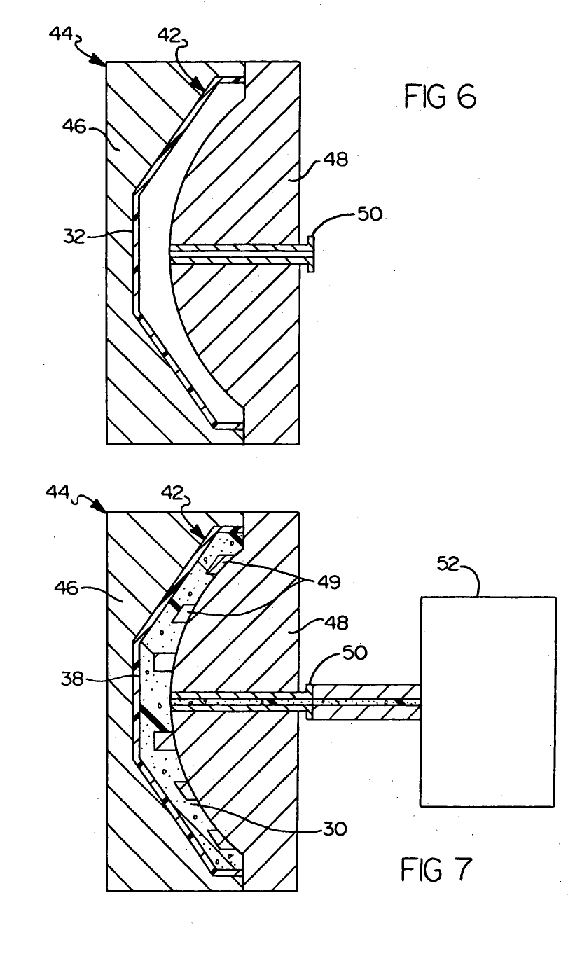

As shown in FIG. 6, in a following step, shaped film member 42 is transferred to a second, injection type mold 44. Mold 44 includes two halves, a first half 46 and a second half 48, respectively. Shaped film member 42 is positioned within first half 46 of mold 44 such that clear layer 32 is in contact with first half 46. A resulting open cavity adjacent to shaped film member 42 is in communication with a nozzle 50. The purpose for nozzle 50 is to provide an injection path for foam 30 (shown in FIG. 3).

As next shown in FIG. 7, following placement of shaped film member 42 adjacent to first half 46 of mold 44, second half 48 of mold 44 is closed against first half 46. FIG. 7 also shows the optional use of a plurality of pins 49 joined to second half 48 of mold 44. The purpose of pins 49 is to create at least one and preferably a plurality of the cavities 31 (shown in FIG. 3) within foam 30. Nozzle 50 is connected to a molding machine 52. Molding machine 52 can include multiple types of equipment, including, but not limited to, injection molding machines and extrusion molding machines known in the art. Preheated and liquefied foam 30 is injected by molding machine 52 via nozzle 50 into mold 44, filling the open cavity adjacent to shaped film member 42. The process of injecting foam 30 into mold 44 bonds foam 30 to back layer 38 of film 28 (shown in FIG. 4). The bonding of foam 30 to film 28 occurs either by chemical reaction between the materials or by thermal fusing of the materials based on the temperature of foam 30 and the combination of materials selected. After a suitable period of time to allow foam 30 to cool to a substantially rigid state, mold 44 is opened and a finished component part such as front bumper unit 12 (shown in FIG. 2) is removed from mold 44. The finished component part includes foam 30 bonded to shaped film member 42 (film 28 formed into a desired shape).

By bonding foam 30 to film 28, foam 30 adds structural rigidity and stiffness to the finished part. This allows film thickness “A” of film 28, and particularly the more expensive clear layer 32 and color layer 34 to be maintained at minimum thicknesses. The process of the present invention also produces finished parts which do not require subsequent fit-up, assembly or trimming steps, required when separately formed film and foam layers are mechanically joined.

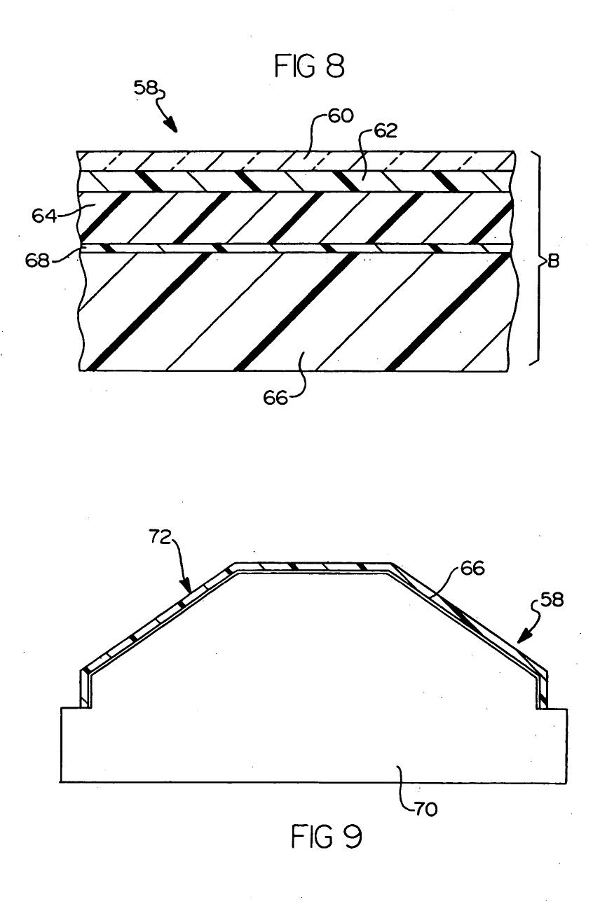

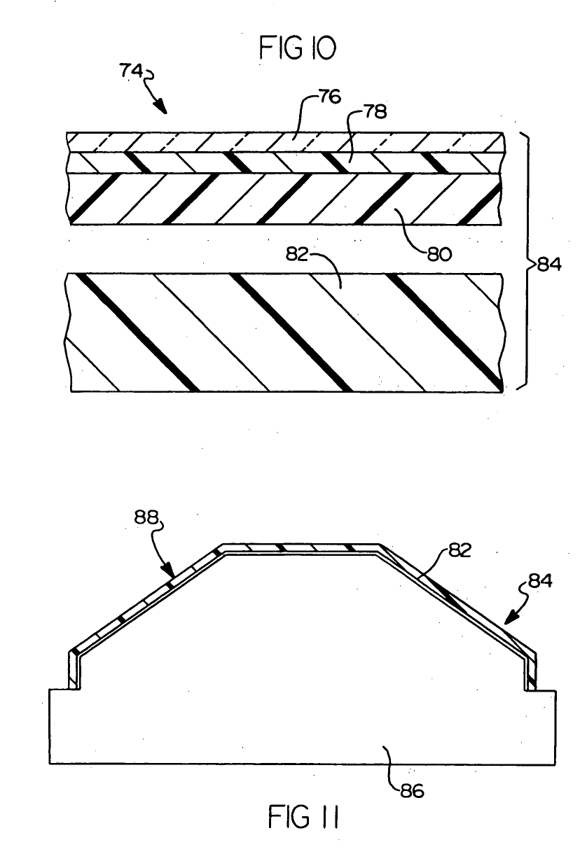

As shown in FIGS. 8 and 9, in another preferred embodiment of the present invention, a multilayer film having a foam layer is co-extruded. In this embodiment, a co-extruded film 58 having a material thickness “B” includes a clear layer 60, a color layer 62, a bulk layer 64, and a foam layer 66. An optional backing layer 68 can also be used, including a polymeric material or an adhesive, operable to bond bulk layer 64 to foam layer 66. The co-extruded film 58 is then preheated as necessary and transferred to a pre-cooled thermoforming mold 70 of a thermoforming device (not shown), or preheated after transfer, where co-extruded film 58, having foam layer 66 in contact with mold 70, is molded to form a finished part 72.

As shown in FIGS. 10 and 11, in yet another preferred embodiment of the present invention, a co-extruded film 74 (similar to film 28 shown in FIG. 4) is formed, having a clear layer 76, a color layer 78 and a bulk layer 80. A separately preformed foam layer 82 is formed by the process disclosed herein, having a material thickness “B”, and both a density and stiffness permitting bending/coiling of foam layer 82. Foam layer 82 is rolled out or positioned and laminated (bonded) to bulk layer 80 of co-extruded film 74, forming a structure 84. Structure 84 is transferred to a thermoforming mold 86 (similar to mold 40 shown in FIG. 5), having foam layer 82 in contact with mold 86, and thermoformed into a final part 88.

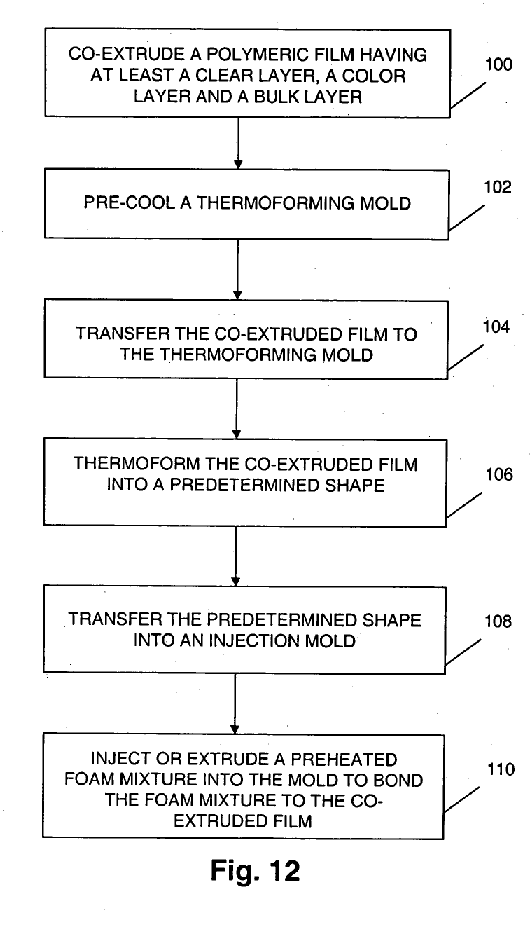

FIG. 12 summarizes exemplary operations for forming a finished part of the present invention. In an operation 100, a polymeric film having at least a clear layer, a color layer and a bulk layer is co-extruded. In an operation 102, a thermoforming mold is pre-cooled. In a following operation 104, the co-extruded film is transferred to the thermoforming mold. Following this, in an operation 106, the co-extruded film is thermoformed into a predetermined shape. In a next operation 108, the predetermined shape is transferred into an injection mold. In a further operation 110, a preheated foam mixture is pressure injected or extruded into the injection mold, bonding the foam mixture to the co-extruded film.

To simplify the process of the present invention, it is preferable to “index” several machines and several operations, such that the relatively thin film 28 and the interim parts are handled only a minimum number of times. In this regard, after thermoforming the co-extruded film, the formed part is moved by hand or robot from the thermoform station to the machine adding the foam to the part. Next, the part is trimmed in either this location or at an immediate, subsequent operation, if needed. In a preferred embodiment, it is desirable to quickly (within about 15 minutes or less, depending on part cooling times) transfer co-extruded film 28, co-extruded film 58, or co-extruded film 74 directly to the thermoforming mold, to eliminate any additional handling steps such as relocating, stacking, recovering and/or storing of the co-extruded film 28, 58 or 74, if multiple units of either co-extruded film 28, 58 or 74 are sequentially formed.

By forming the foam layers or parts of the present invention using injection molding or extrusion molding processes, the foam is allowed to expand in the mold at relatively low pressure (approximately 300 psi or lower). This permits the mold material to be of lower strength and therefore lower cost material, such as aluminum. The foam layers or parts of the present invention can range from low density (elevated percentage of blowing agent compared to polymer base material) to high density (very low percentage of blowing agent compared to the polymer base material). Foam density is also controlled using one or a plurality of nozzles 50, which control the rate and injection location of foam material into the mold.

The foam substrate on a polymeric film device and the method of manufacture of the present invention offer several advantages. First, the co-extruded film is thermoformed, which provides a desired, preformed shape. By injection molding or extruding a heated foam mixture into a mold containing a co-extruded film, the foam bonds to the polymeric film and a unitary part is formed.

The foam mixture bonded to the preformed film provides the finished part with a foam backing in a single step, eliminating the need to separately form the film and the foam part and subsequently join these two component parts. By bonding the foam material to the film material using the process of the present invention, a reduced wall thickness for the film can be employed because the process steps move the film in pre-finished/preheated form to the machine that adds the foam layer. By reducing the thickness of the film layer of the present invention, cost of the overall part is also reduced.

The description of the invention is merely exemplary in nature and, thus, variations that do not depart from the gist of the invention are intended to be within the scope of the invention. Such variations are not to be regarded as a departure from the spirit and scope of the invention.

1. A molded device, comprising:
a co-extruded multilayer film, including at least:
a color layer; and
a bulk layer joined to the color layer; and
a foam layer bonded to the bulk layer of the multilayer film;
wherein the film and the foam layer together operably form a structural unit.

2. The device of claim 1, comprising:
a clear layer bonded to the color layer opposite to the bulk layer;
wherein the clear layer is operably formed of a polymeric material.

3. The device of claim 2, comprising a backing layer joined to the bulk layer opposite from the color layer.

4. The device of claim 3, wherein each of the color layer, the bulk layer, the backing layer and the foam layer comprise a polymeric material.

5. The device of claim 4, wherein the polymeric material of the foam layer comprises a polyethylene material.

6. The device of claim 4, wherein the polymeric material of the foam layer comprises at least one of polyurethane, polyethylene, polypropylene, polyester, polycarbonate/polyester alloy, ethylene vinyl acetate copolymer, amide, ionomer, polycarbonate, acrylonitrile butadiene styrene, polybutylene therephthalate, thermoplastic olefin, thermoplastic elastomer, polyethylene terephtalate, polyethylene terephtalate copolymer with glycol, acetyl, and/or polyphenyline oxide.

7. The device of claim 5, wherein the polymeric material of the foam layer further comprises a blowing agent.

8. The device of claim 6, wherein the polymeric material of the foam layer further comprises a blowing agent.

9. The device of claim 1, wherein the multilayer film comprises a thickness ranging from approximately 0.30 mm to approximately 1.25 mm.

10. The device of claim 1, wherein the multilayer film comprises a nominal thickness of approximately 0.76 mm.

11. A method for forming a multilayered polymeric component, comprising:
coextruding a film layer using the steps of:
forming a color layer; and
binding the color layer to a bulk layer;
thermoforming the film layer;
positioning the thermoformed film layer in a mold of a molding machine; and
bonding a foam layer in the mold to the thermoformed film layer.

12. The method of claim 11, comprising joining the bulk layer to a backing layer prior to bonding the foam layer.

13. The method of claim 11, comprising forming the film layer from at least one polymeric material.

14. The method of claim 13, comprising:
pre-cooling a thermoforming mold prior to the thermoforming step; and
pre-heating the film layer prior to the thermoforming step.

15. The method of claim 11, comprising fusing the foam layer to the bulk layer during the bonding step.

16. The method of claim 11, comprising applying an adhesive between the foam layer and the bulk layer during the bonding step.

17. The method of claim 11, comprising overcoating a side of the color layer opposite to the bulk layer with a clear layer prior to the thermoforming step.

18. The method of claim 11, comprising injection molding the foam layer.

19. The method of claim 11, comprising extrusion molding the foam layer.

20. A process for molding a vehicle component part, comprising:
creating a polymeric film;
thermoforming the polymeric film into a predetermined shape;
positioning the predetermined shape in an injection mold; and
injecting a preheated foam mixture into the mold to operably bond the foam mixture to the polymeric film.

21. The process of claim 20, comprising molding the polymeric film using the steps of:
forming a color layer;
overcoating the color layer with a clear layer on a first face of the color layer; and
binding a second face of the color layer to a bulk layer.

22. The method of claim 21, comprising:
joining the bulk layer to a backing layer; and
bonding the foam mixture to the backing layer opposite to the bulk layer.

23. The process of claim 20, comprising combining a polymeric resin and a foaming agent to operably form the foam mixture.

24. The process of claim 23, comprising:
preheating the foam mixture in an injection molding machine; and
injecting the foam mixture using the injection molding machine.

25. The process of claim 23, comprising:
preheating the foam mixture in an extrusion molding machine; and
extruding the foam mixture using the extrusion molding machine.

26. The process of claim 20, comprising pre-cooling a thermoforming mold prior to the thermoforming step.

27. The process of claim 26, comprising:
preheating the polymeric film prior to the thermoforming step; and
positioning the preheated polymeric film in contact with the pre-cooled thermoforming mold.

28. The process of claim 20, comprising forming the injection mold of an aluminum material.

29. A method for forming a multilayered polymeric component, comprising:
simultaneously coextruding a multiple element film having at least a color layer, a bulk layer and a foam layer, including the steps of:
binding the color layer to the bulk layer; and
bonding a foam layer to the bulk layer opposite to the color layer;
sequentially transferring the multiple element film to a thermoforming device; and
thermoforming the multiple element film to operably form a completed part.

30. The method of claim 28, comprising:
forming a mold having the completed part shape; and
pre-cooling the mold to one of an ambient and a sub-ambient temperature.

31. A process for molding a component, comprising:
coextruding a multiple layer polymeric film having at least a color layer and a bulk layer;
forming a foam sheet;
bonding the foam sheet to the bulk layer to operably form a sub-component;
transferring the sub-component to a thermoforming device; and
thermoforming the sub-component into a completed component.

32. The process of claim 31, comprising controlling at least a density of the foam sheet to operably permit bending of the foam sheet.

33. The process of claim 32, comprising:
coiling the foam sheet after the forming step; and
un-coiling the foam sheet in preparation for the bonding step.

34. The process of claim 33, comprising extrusion molding the foam sheet from a polymeric base material and a blowing agent.

35. The process of claim 31, comprising preheating the sub-component prior to the thermoforming step.

36. The process of claim 30, comprising pre-cooling a mold of the thermoforming device prior to the thermoforming step.
